(19) United States
(12) Patent Application Publication
(10) Pub. No.: US 2002/0118688 A1
(43) Pub. Date: Aug. 29, 2002

(54) Generation of fast busy signals in data networks

(76) Inventor: Ravi Jagannathan, Redwood City, CA (US)

Correspondence Address: MR. BILL GALLIANI, COOLEY GODWARD LLP, 5 PALO ALTO SQUARE, PALO ALTO, CA, 94306, US

(21) Appl. No.: 09/747,668

(22) Filed: Dec. 21, 2000

Related U.S. Application Data
(60) Provisional application No. 60/243,344, filed on Oct. 25, 2000.

(51) Int. Cl. H04L 12/28

(52) U.S. Cl. 370/410; 709/229

(57) ABSTRACT

A data network includes a calling device and a called device. When a request to make a connection from the calling device to the called device is received, a resource information system (RIS) coupled to a softswitch queries a model to determine if there are enough resources between the calling and called devices to make the connection at a predetermined level of quality of service (QOS). If so, the RIS informs the softswitch that the requested connection can be made. Otherwise, a fast busy signal is provided to the calling device. In one embodiment, the model provides the RIS information about network resources such as bandwidth and QOS factors. The model is updated when any of the resources described in it is reserved, released, or modified; thereby allowing the model to provide up-to-date resource information that can be used to make an informed decision on whether a connection at a predetermined level of QOS can be made.

### CROSS-REFERENCE TO RELATED APPLICATION

This application claims priority on and incorporates by reference in its entirety U.S. Provisional Application No. 60/243,344, entitled “A METHOD FOR IMPLEMENTING ‘FAST BUSY SIGNAL’ FOR SWITCHES IN CASE OF INSUFFICIENT RESOURCES,” Attorney Docket No.47242.00012, filed on Oct. 25, 2000, by Ravi Jagannathan.

### COPYRIGHT NOTICE

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

1. Field of the Invention

This invention relates generally to data networks, and more particularly to methods and associated apparatus for generating fast busy signals.

2. Description of the Background Art

In a Public Switched Telephone Network (PSTN), a telephone connection is initiated by using a local telephone to dial the number of a remote telephone. If the remote telephone is not being used, traditional telephone switches, such as Class 4 and Class 5 switches, connect the local telephone to the remote telephone. Otherwise, a busy signal is provided to the local telephone.

Another type of busy signal is the so-called “fast busy signal.” Like a regular busy signal, a fast busy signal indicates that a connection to a remote telephone cannot be made. Unlike a regular busy signal, however, a fast busy signal is generated when all telephone lines to the remote location are already in use. Thus, a fast busy signal may be received even if the remote telephone is available. Because PSTN's in the United States are designed with over-capacity, fast busy signals are more prevalent with international calls.

With the advent of readily accessible data networks, voice over data (VOD) services have become a viable alternative to regular telephone calls. VOD services, which include voice over IP, voice over XDSL (DSL, ADSL, VDSL, HDSL etc.) and voice over ATM, provide an audio connection by encapsulating audio information in packets, and transporting the packets over a data network. VOD services are becoming popular because, among other advantages, they allow for free long distance calls over a public data network such as the Internet. In a typical VOD service, a connection between two devices on a network is made as long as both devices are available and the communications lines between the devices are operational. For example, a connection between two computers can be made over the Internet if the two computers are running and available to send and receive packets. However, the resulting connection can be frustratingly slow or totally non-functional when made during peak Internet utilization periods. This results in highly dissatisfied users who continue to wait around hoping the connection will become useable at some point. Worse, valuable assets are tied up working with the non-useable connection when these assets can be diverted to other, more productive tasks.

Referring to FIG. 1, there is shown a schematic diagram of a data network 100 in the prior art. Network 100 includes a calling device 101, a called device 102, a softswitch 103, and signaling path 104 (i.e., 104A and 104B). Softswitch 103 is a conventional softswitch and thus allows a connection to be made over a data path 105 regardless of the traffic thereon. Thus, connecting devices 101 and 102 when data path 105 is already carrying too much traffic results in a very slow connection. In some cases, the resulting connection does not work at all and the user trying to initiate a VOD service from device 101 will not hear anything on his end.

Unfortunately, conventional techniques for generating fast busy signals in a PSTN cannot be readily employed in a data network because of differences in architecture, components used, and operation. For example, generation of fast busy signals in a PSTN is relatively straightforward because the number of telephone lines in a trunk is readily known; when all the telephone lines are in use, the next caller will get a fast busy signal. In contrast, a single communications line in a data network can support multiple users at the same time. Further, a connection between two devices on a data network can be created as long as the devices and the communications lines between them are operational, regardless of the number of users already on the network. Thus, a technique for generating fast busy signals in a data network is highly desirable.

### SUMMARY

The present invention relates to a method and associated apparatus for generating fast busy signals in a data network. It may be used in a variety of data network services including voice over data, video, and multimedia to name a few.

In one embodiment, a data network includes a calling device and a called device. When a softswitch receives a request to make a connection from the calling device to the called device, the softswitch asks a resource information system (RIS) if there are enough resources between the calling and called devices to make a connection at a predetermined level of quality of service (QOS). If so, the RIS informs the switch that the connection can be made. Otherwise, a fast busy signal is provided to the calling device.

In one embodiment, a model coupled to the RIS contains information about network resources such as bandwidth and QOS factors. The model is updated when any of the resources described in it is reserved, released, or modified; thereby allowing the model to contain up-to-date resource information that can be used by the RIS in determining whether a connection at a predetermined level of QOS can be made over the data network.

These and other features and advantages of the present invention will be apparent to persons of ordinary skill in the art upon reading the entirety of this disclosure, which includes the accompanying drawings, appendices, and claims.

### BRIEF DESCRIPTION OF THE DRAWINGS

FIG. 1 shows a schematic diagram of a data network in the prior art.

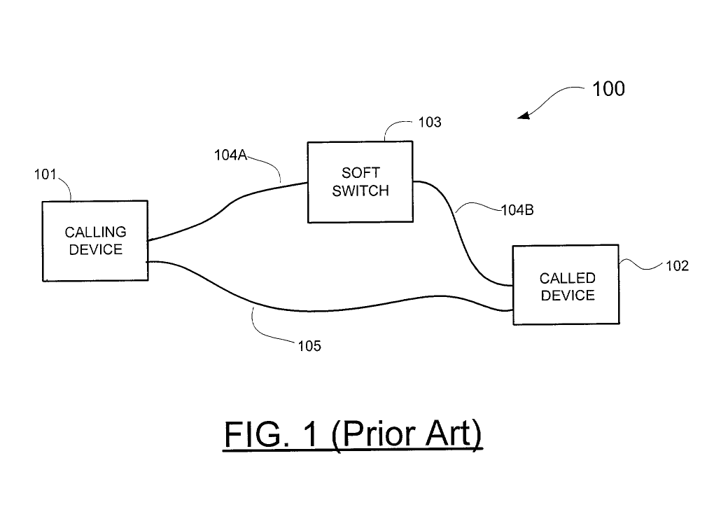

FIG. 2 shows a schematic diagram of a data network in accordance with an embodiment of the present invention.

FIG. 3 shows a flow diagram of a method for generating a fast busy signal in accordance with an embodiment of the present invention.

FIG. 4 shows a computer in the prior art.

The use of the same reference label in different figures indicates the same or like elements.

### DETAILED DESCRIPTION

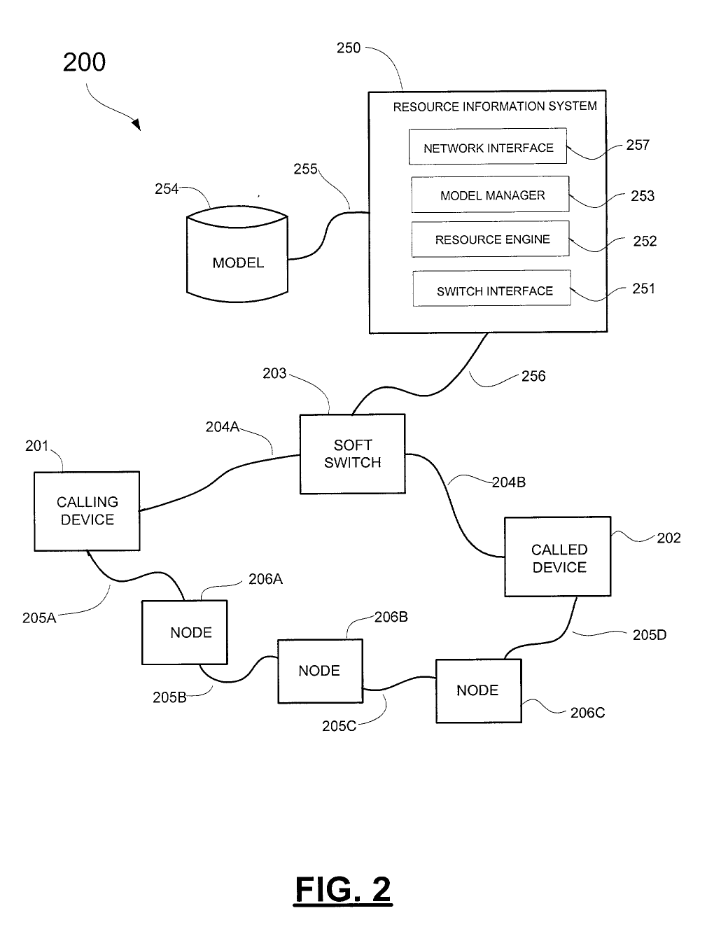

Turning now to FIG. 2, there is shown a schematic diagram of a data network 200 in accordance with an embodiment of the present invention. For clarity of illustration, FIG. 2 shows communications paths (e.g., signaling and/or data paths), and not physical interconnections between the components of network 200. For example, a resource information system (RIS) 250 is generally coupled to network 200 and may thus communicate with a node 206B using communications paths not specifically shown. As shown in FIG. 2, network 200 includes a calling device 201, a called device 202, a softswitch 203, nodes 206 (i.e., node 206A, node 206B, . . . ), and RIS 250. Devices 201 and 202 may be any conventional communications devices including personal computers, servers, personal digital assistants, media players, IP phones, traditional telephones coupled to voice gateways, and web-enabled cellular phones. Network 200 may also include additional communications devices.

In one embodiment, softswitch 203 is a conventional softswitch and may be of the type manufactured by Sonus Networks, Inc. and Cisco Systems, Inc. A typical softswitch provides signaling functions for initiating a connection between devices such as devices 201 and 202. Unlike a traditional telephone switch, however, a typical softswitch does not have a mechanism for allowing network traffic to go through the softswitch. In data network 200, softswitch 203 initiates a connection between devices 201 and 202 using a signaling protocol over signaling path 204 (i.e. 204A, 204B). Once the connection is setup, data transfer between the devices occurs over data path 205 (i.e. 205A, 205B, . . . ). As shown in FIG. 2, there may also be several nodes 206 (e.g. routers, gateways, integrated access devices etc.) along data path 205. Signaling path 204 and data path 205 may be any conventional data communications lines including Ethernet, Digital Subscriber Line (DSL), Asymmetric Digital Subscriber Line (ADSL), and Asynchronous Transfer Mode (ATM) to name a few.

Network 200 also includes an RIS 250 coupled to a model 254. In one embodiment, RIS 250 is on a computer running the Linux operating system. Although RIS 250 and model 254 are depicted as separate components of network 200, they may be embodied in a single computer, in softswitch 203, or separately in different computers coupled to network 200. If running on the same computer or softswitch, RIS 250 and model 254 communicate by passing messages directly to one another. Otherwise, RIS 250 and model 254 may conventionally communicate using TCP/IP, for example.

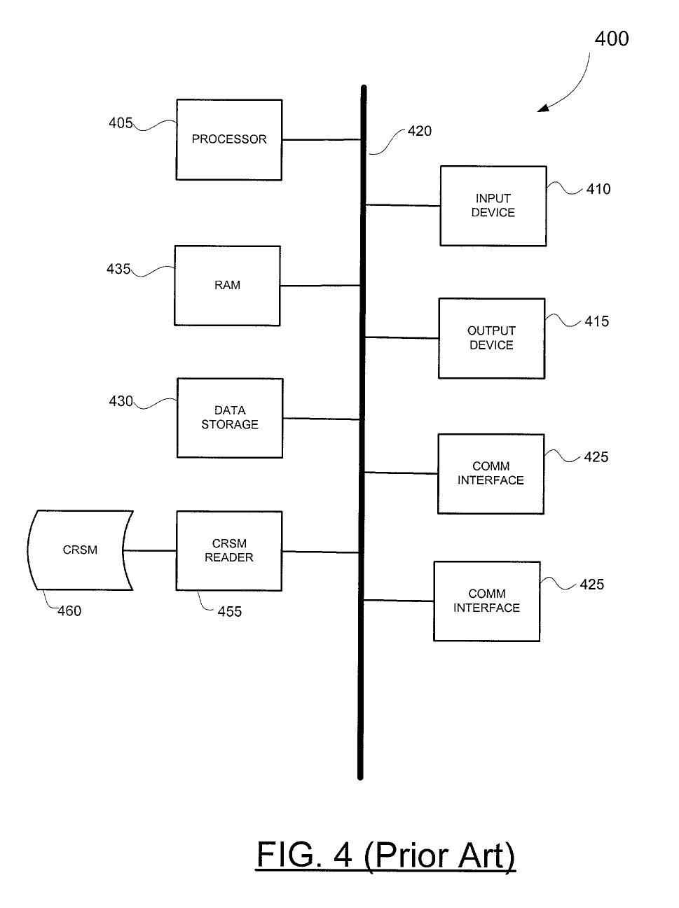

FIG. 4 is a schematic diagram of a computer 400 which may be used in the present invention. Computer 400 includes a processor 405, such as an Intel Pentium™ microprocessor or a Motorola Power PC™ microprocessor, coupled to a bus 420. Computer 400 further includes an input device 410 such as a keyboard or mouse, an output device 415 such as a cathode ray tube or flat panel display, a communications interface 425 such as an Ethernet card, data storage 430 such as a magnetic disk, and internal storage 435 such as Random-Access Memory (RAM), each coupled to bus 420. Bus 420 may be coupled to a network such as data network 200 via interface card 425. Persons of ordinary skill in the art will recognize that, although data storage 430 and internal storage 435 are illustrated as integral units, data storage 430 and internal storage 435 can be distributed units. Persons of ordinary skill in the art will recognize that computer 400 may also include additional components, such as voice cards, multimedia cards, additional memory, additional processors, input/output lines for transferring information across a hardware channel etc. Also, programs and data may be received by and stored in computer 400 in alternative ways. For example, a computer-readable storage medium (CRSM) reader 455 such as a magneto-optical reader, CD-ROM drive, floppy drive, and high density removable drive may be coupled to communications channel 420 for reading a computer-readable storage medium (CRSM) 460 such as a magnetic disk, floppy disk, a hard disk, a magneto-optical disk, smart cards etc. Accordingly, computer 400 may receive programs and data via CRSM reader 455.

Referring back to FIG. 2, RIS 250 includes a switch interface 251 for communicating with softswitch 203 using a conventional protocol such as the Simple Network Management Protocol (SNMP), Common Management Information Protocol (CMIP), or Session Initiation Protocol (SIP). RIS 250 may also communicate with softswitch 203 using a command line interface (CLI), a telnet session, or a native protocol of softswitch 203. Although RIS 250 is schematically depicted as coupled to softswitch 203 via a connection 256, it is to be understood that RIS 250 is generally coupled to network 200 and may communicate with other components of network 200 using a network interface 257.

Of course, all components described in the present disclosure, including the above described components of network 200, are provided for illustration purposes and not limiting. For example, RIS 250 may use operating systems such as Microsoft Windows NT™, UNIX, and Sun Solaris™ instead of Linux.

In one embodiment, RIS 250 and model 254 are parts of a virtual service enabler system of the type disclosed in commonly-owned U.S. patent application No. 09/586,732 entitled “SYSTEM AND METHOD FOR ENABLING SERVICES AND BILLING FOR SERVICES IN A COMPUTER NETWORK ENVIRONMENT,” filed on Jun. 5, 2000, and U.S. Provisional Application No. 60/199,308, entitled “Virtual Service Enabler,” filed on Apr. 24, 2000. The just mentioned U.S. patent application and U.S. Provisional Application are incorporated herein by reference in their entirety.

Model 254 contains information about the various resources of network 200. As used in the present disclosure, the term “resource” includes network components and associated properties that affect the performance of a network. An example of a resource is bandwidth, which indicates the amount of traffic the network can support. Because bandwidth is a property of the network components along a particular path, bandwidth can be different on different paths. Bandwidth is a resource that can be reserved and released. That is, the available bandwidth decreases as the number of connections is increased, and increases as connections are terminated. Some services require more bandwidth than others. For example, a real-time video conferencing session requires more bandwidth than a voice over data (VOD) service.

“Quality of Service” (QOS) is another example of a network resource. QOS refers to various factors which affect the quality of a service. Such factors include latency, jitter, and availability. For a VOD service, QOS affects the voice quality heard on both ends of the connection.

“Latency” is a measure of the delay along a particular path. Like bandwidth, latency is a property of the network components on the path; thus, the delay through each path can be different. Further, different applications have different latency requirements. For example, a VOD service is more sensitive to latency than a web browsing session.

“Jitter” is a measure of latency variation along a path. The more latency varies, the higher the jitter.

“Availability” indicates the probability of a transmitted packet reaching its destination. The condition of network components and the amount of traffic on the network affect availability. For example, the availability of a particular path is zero if a required network component along that path is not operational. Also, availability decreases as more connections are made on the network.

In one embodiment, bandwidth is also considered a QOS factor. This is because even if there is enough bandwidth to support a VOD service, there may not be enough bandwidth to meet a predetermined level of QOS. The higher the required QOS level, such as when providing a high fidelity VOD service for a particular user, the more bandwidth is required.

Other network resources and network related information may also be stored in model 254. For example, the topology of network 200 may be stored in model 254 to keep track of the various communications paths that may be taken. User information, such as service area, directory number, and billing information may be stored in model 254.

RIS 250 includes a model manager 253 for administering the contents of model 254. Model manager 253 updates model 254 when a resource described in the model is reserved, released, or modified. For example, information regarding the remaining bandwidth on data path 205 is updated when the path is provisioned to support a VOD service between calling device 201 and called device 202. RIS 250 may be notified of the provisioning event by softswitch 203, a network management system (not shown), or any component coupled to network 200. RIS 250 may also receive resource status updates from any component coupled to network 200 using the Common Open Policy Service (COPS) protocol, for example. The COPS protocol, in general, is well known and described in the Internet Engineering Task Force (IETF) document: “The COPS (Common Open Policy Service) Protocol,” RFC 2748.

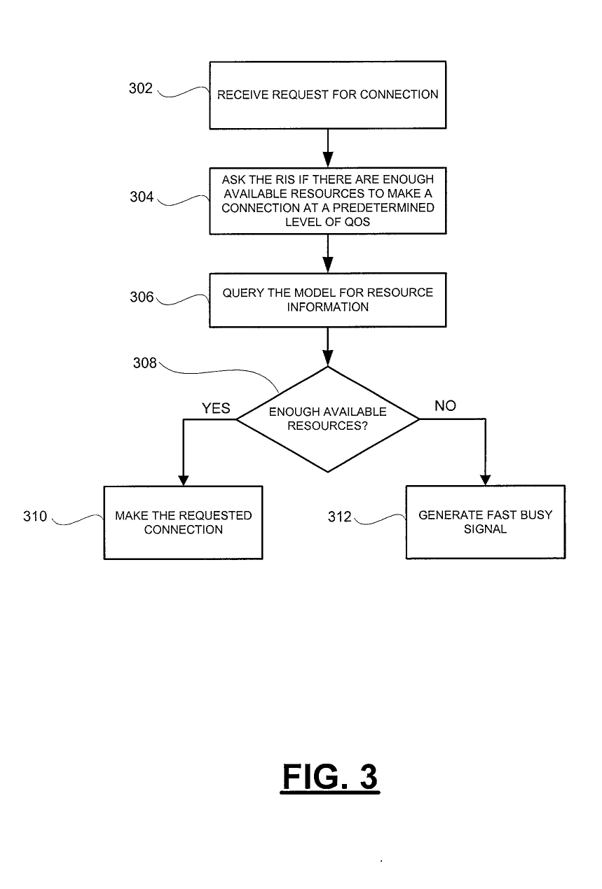

FIG. 3 shows a method for generating a fast busy signal in accordance with an embodiment of the present invention. In step 302, softswitch 203 receives a request from calling device 201 for a connection to called device 202. Softswitch 203 then asks RIS 250 if there are enough available resources to support the requested connection at a predetermined level of QOS along data path 205 connecting devices 201 and 202 (step 304). In RIS 250, switch interface 251 may receive the resource question along with service information from softswitch 203. The service information may include, among other information, a list of the nodes on data path 205 and the QOS level required by the requested connection. Information received from softswitch 203 is forwarded by switch interface 251 to model manager 253, which then queries model 254 for information regarding data path 205 (step 306). Examples of information that can be provided by model 254 include the available bandwidth of nodes 206, and the latency, jitter, and availability through data path 205. A resource engine 252 uses the information provided by model 254 to determine if there are enough available resources to support the requested connection (step 308). In one embodiment, resource engine 252 compares the bandwidths, latency, jitter, and availability information provided by model 254 with that required to support the requested connection to determine if there are enough available resources.

If there are enough available resources to support the requested connection, switch interface 251 so informs softswitch 203. Accordingly, softswitch 203 makes the requested connection (step 310). Otherwise, a fast busy signal is provided to calling device 201 (step 312). The fast busy signal may be generated by softswitch 203 or another component coupled to device 201. The form of the fast busy signal depends on network topology and the devices used. For example, the fast busy signal may be in the form of an audio tone if calling device 201 is a traditional telephone coupled to a device such as an integrated access device (IAD), or a dialog box if calling device 101 has a display screen. Softswitch 203 may also initiate the generation of the fast busy signal by sending a packet to another network component (e.g., IAD-like device), which then generates a fast busy signal for calling device 201.

If there is an alternative data path from calling device 201 to called device 202, softswitch 203 may ask RIS 250 if that path has enough resources to support the requested connection. If so, softswitch 203 may choose to connect devices 201 and 202 using the alternative path instead of generating (or initiating the generation of) a fast busy signal.

In one embodiment, model 254 includes an Oracle 8™ data base and runs on a Sun Microsystems™ computer. Information about network 200, including its components, topology, and resources are described in Resource Description Framework (RDF) format and stored in the database. RDF, in general, is well known; e.g., see “Resource Description Framework (RDF) Model and Syntax Specification,” W3C Recommendation 22 February 1999, Internet URL:<http://www.w3.org/TR/RECrdf-syntax/>; the World-Wide Web Consortium (W3C) site on the Internet URL: <http://www.w3.org>; Eric Miller, “An Introduction to the Resource Description Framework,” D-Lib Magazine (ISSN 1082-9873), May 1998.

In the database of model 254, the RDF descriptions may be stored as RDF triplets composed of a “subject”, a “predicate”, and an “object”. The RDF descriptions may also be stored as a flat file, which may be parsed to extract its constituent RDF triplets. Generally speaking, the “subject” has a property referred to as the “predicate”, which has a value referred to as the “object.” For example, the bandwidth of node 206A may be described in an RDF triplet having “node 206A” as the subject, its bandwidth as the predicate, and a bandwidth value (e.g., 64 Kbps) as the object. To get resource information from model 254, queries are sent to the database to retrieve the contents of the RDF triplets. The contents of the RDF triplets are kept current by saving new values in the database.

The use of a model to store and manage network resource information provides several advantages. For one, the model provides a resource information system access to information that would otherwise be ignored in determining whether a connection can be made. For example, the resource information system may consider not just whether there are enough ports or bandwidth to make a connection, but also whether the resulting connection meets a QOS level expected by a particular user. The model is extensible. The number of additional resources (and other network related information) that may be added to the model is limited only by the size of the database. The model is easily updated using database commands, thereby helping keep the stored resource information current. Furthermore, the model is readily searchable to obtain specific resource information.

Appendices A and B, which are integral parts of the present disclosure, show representative RDF descriptions for various network resources. Appendix A is an example of an RDF schema while Appendix B is an example of an instance using the schema of Appendix A. Generally speaking, a schema outlines the format of RDF descriptions. Appendix A provides the schema for availability, capacity, jitter, latency, the bandwidth of a node (IADBandwidth), the IP address of the node (iADIpAddress), a port of the node (iADPort), and customer related information (name, directory number, etc.) to name a few.

An RDF instance provides the current values of RDF descriptions. With reference to the schema shown in Appendix A, the RDF instance of Appendix B provides the following information:

(a) A node from vendor Cisco, model no. uBR904, serial no. 12345, has a bandwidth of 64 Kbps (bapna_{—}00033).

(b) A customer named Bapna has a billing ID of 1010111 and directory number of (408)541-1422. The customer is in the service area Sunnyvale, and is assigned port 0 of a node having an IP address of 1.1.1.1 (bapna_{—}00034).

(c) A communications path identified in Appendix B as bapna_{—}00035 has an availability of 99%, bandwidth of 64 Kbps, latency of 50ms, and jitter of 0.01.

Of course, Appendices A and B may be extended to include other resource and network related information.

A method and associated apparatus for generating fast busy signals in a data network have been disclosed. While specific embodiments have been provided, it is to be understood that these embodiments are for illustration purposes and not limiting. Many additional embodiments will be apparent to persons of ordinary skill in the art reading this disclosure. For example, although the present invention is ideally suited for use in VOD services, persons of ordinary skill in the art will appreciate that the present invention may be generally employed to generate fast busy signals in a wide variety of application including video and multimedia services. Furthermore, the invention may be employed to work with any network component including routers, gateways, and integrated access devices, in addition to softswitches. Thus, the present invention is limited only by the following claims.

APPENDIX A
(C) 2000 Last Mile Services, Inc. All Rights Reserved.
<?xml version=‘1.0′ encoding=‘ISO-8859-1’?>
<!DOCTYPE rdf:RDF [

<!ENTITY s ‘http://www.w3.org/TR/1999/PR-rdf-schema-19990303#’>
<!ENTITY a ‘http://www.lastmileservices.com\rdf/#’>
<!ENTITY rdf ‘http://www.w3.org/1999/02/22-rdf-syntax-ns#’>

]>
<rdf:RDF xmlns:s=“&s;”

xmlns:a=“&a;”
xmlns:rdf=“&rdf;”>

<s:Class rdf:about=“&a;CustomerData”>

<s:subClassOf rdf:resource=“&s;Resource”/>

</s:Class>
<rdf:Property rdf:about=“&a; IADBandwidth”>

<a:SLOT-MAXIMUM-CARDINALITY>1</a:SLOT-MAXIMUM-CARDINALITY>
<s:range rdf:resource=“&s;Literal”/>

</rdf:Property>
<s:Class rdf:about=“&a;IPSoftswitch”>

<s:subClassOf rdf:resource=“&s;Resource”/>

</s:Class>
<s:Class rdf:about=“&a;Qos”>

<s:comment>Quality of service is described in terms of the

properties</s:comment>

<s:subClassOf rdf:resource=“&s;Resource”/>

</s:Class>
<rdf:Property rdf:about=“&a;QosList”>

<s:domain rdf:resource=“&a;IPSoftswitch”/>
<s:range rdf:resource=“&a;Qos”/>

</rdf:Property>
<s:Class rdf:about=“&a;VoIPQos”>

<s:subClassOf rdf:resource=“&a;Qos”/>

</s:Class>
<rdf:Property rdf:about=“&a;availability”>

<a:SLOT-MAXIMUM-CARDINALITY>1</a:SLOT-MAXIMUM-CARDINALITY>
<s:comment>Assurance that the traffice will reach its destination

sucessfully</s:comment>

<s:domain rdf:resource=“&a;Qos”/>
<s:range rdf:resource=“&s;Literal”/>

</rdf:Property>
<rdf:Property rdf:about=“&a;bapna_00031”>

<a:SLOT-MAXIMUM-CARDINALITY>1</a:SLOT-MAXIMUM-CARDINALITY>
<s:range rdf:resource=“&s;Literal”/>

</rdf:Property>
<rdf:Property rdf:about=“&a; capacity”>

<a:SLOT-MAXIMUM-CARDINALITY>1</a:SLOT-MAXIMUM-CARDINALITY>
<s:comment>total amount of bandwidth available on a link</s:comment>
<s:domain rdf:resource=“&a;Qos”/>
<s:range rdf:resource=“&s;Literal”/>

</rdf:Property>
<rdf:Property rdf:about=“&a;classOfService”>

<a:SLOT-MAXIMUM-CARDINALITY>1</a:SLOT-MAXIMUM-CARDINALITY>
<s:comment>Specifies the class of service : example = 1FRB</s:comment>
<s:domain rdf:resource=“&a;CustomerData”/>
<s:range rdf:resource=“&s;Literal”/>

</rdf:Property>
<rdf:Property rdf:about=“&a;customerBillingId”>

<a:SLOT-MAXIMUM-CARDINALITY>1</a:SLOT-MAXIMUM-CARDINALITY>
<s:comment>customer billing Identification</s:comment>
<s:domain rdf:resource=“&a;CustomerData”/>
<s:range rdf:resource=“&s;Literal”/>

</rdf:Property>
<rdf:Property rdf:about=“&a;customerData”>

<s:range rdf:resource=“&a;CustomerData”/>
<s:domain rdf:resource=“&a;IPSoftswitch”/>

</rdf:Property>
<rdf:Property rdf:about=“&a;customerName”>

<a:SLOT-MAXIMUM-CARDINALITY>1</a:SLOT-MAXIMUM-CARDINALITY>
<s:domain rdf:resource=“&a;CustomerData”/>
<s:range rdf:resource=“&s;Literal”/>

</rdf:Property>
<rdf:Property rdf:about=“&a;directoryNumber”>

<a:SLOT-MAXIMUM-CARDINALITY>1</a:SLOT-MAXIMUM-CARDINALITY>
<s:comment>Directory number allocated to the customer</s:comment>
<s:domain rdf:resource=“&a;CustomerData”/>
<s:range rdf:resource=“&s;Literal”/>

</rdf:Property>
<s:Class rdf:about=“&a;iAD”>

<s:subClassOf rdf:resource=“&s;Resource”/>

</s:Class>
<rdf:Property rdf:about=“&a;iADBandwidth”>

<a:SLOT-MAXIMUM-CARDINALITY>1</a:SLOT-MAXIMUM-CARDINALITY>
<s:domain rdf:resource=“&a;iAD”/>
<s:range rdf:resource=“&s;Literal”/>

</rdf:Property>
<rdf:Property rdf:about=“&a;iADIpAddress”>

<a:SLOT-MAXIMUM-CARDINALITY>l</a:SLOT-MAXIMUM-CARDINALITY>
<s:comment>IP address allocated to the customer's premises device

(IAD)</s:comment>

<s:domain rdf:resource=“&a;CustomerData”/>
<s:range rdf:resource=“&s;Literal”/>

</rdf:Property>
<rdf:Property rdf:about=“&a;iADList”>

<s:domain rdf:resource=“&a;IPSoftswitch”/>
<s:range rdf:resource=“&a;iAD”/>

</rdf:Property>
<rdf:Property rdf:about =“&a;iADPort”>

<a:SLOT-MAXIMUM-CARDINALITY>1</a:SLOT-MAXIMUM-CARDINALITY>
<s:comment>Port in IAD to which the customer's device is

attached.</s:comment>

<s:domain rdf:resource=“&a;CustomerData”/>
<s:range rdf:resource=“&s;Literal”/>

</rdf:Property>
<rdf:Property rdf:about=“&a;jitter”>

<a:SLOT-MAXIMUM-CARDINALITY>1</a:SLOT-MAXIMUM-CARDINALITY>
<s:comment>Variation of latency over time</s:comment>
<s:domain rdf:resource=“&a;Qos”/>
<s:range rdf:resource=“&s;Literal”/>

</rdf:Property>
<rdf:Property rdf:about=“&a;latency”>

<a:SLOT-MAXIMUM-CARDINALITY>1</a:SLOT-MAXIMUM-CARDINALITY>
<s:comment>delay experienced by the traffic as it travels across the

network</s:comment>

<s:domain rdf:resource=“&a;Qos/>
<s:range rdf:resource=“&s;Literal”/>

</rdf:Property>
<rdf:Property rdf:about“&a;model”>

<a:SLOT-MAXIMUM-CARDINALITY>1</a:SLOT-MAXIMUM-CARDINALITY>
<s:domain rdf:resource=“&a;iAD”/>
<s:range rdf:resource=“&s;Literal”/>

</rdf:Property>
<rdf:Property rdf:about=“&a;popID”>

<a:SLOT-MAXIMUM-CARDINALITY>1</a:SLOT-MAXIMUM-CARDINALITY>
<s:comment>example = SV−3</s:comment>
<s:domain rdf:resource“&a;CustomerData”/>
<s:range rdf:resource=“&s;Literal”/>

</rdf:Property>
<rdf:Property rdf:about=“&a;serial”>

<a:SLOT-MAXIMUM-CARDINALITY>1</a:SLOT-MAXIMUM-CARDINALITY>
<s:domain rdf:resource=“&a;iAD”/>
<s:range rdf:resource=“&s;Literal”/>

</rdf:Property>
<rdf:Property rdf:about“&a;serviceArea”>

<a:SLOT-MAXIMUM-CARDINALITY>1</a:SLOT-MAXIMUM-CARDINALITY>
<s:domain rdf:resource=“&a;CustomerData”/>
<s:range rdf:resource=“&s;Literal”/>

</rdf:Property>
<rdf:Property rdf:about=“&a;serviceID”>

<a:SLOT-MAXIMUM-CARDINALITY>1</a:SLOT-MAXIMUM-CARDINALITY>
<s:comment>The Identification given to the customer's

service</s:comment>

<s:domain rdf:resource=“&a;CustomerData”/>
<s:range rdf:resource=“&s;Literal”/>

</rdf:Property>
<rdf:Property rdf:about=“&a;vendor”>

<a:SLOT-MAXIMUM-CARDINALITY>1</a:SLOT-MAXIMUM-CARDINALITY>
<s:domain rdf:resource=“&a;iAD”/>
<s:range rdf:resource=“&s;Literal”/>

</rdf:Property>
</rdf:RDF>

APPENDIX B
(C) 2000 Last Mile Services, Inc. All Rights Reserved.
<?xml version=‘1.0’ encoding=‘ISO-8859-1’?>
<!DOCTYPE rdf:RDF [

<!ENTITY a ‘http://www.lastmileservices.com\rdf/#’>
<!ENTITY rdf ‘http://www.w3.org/1999/02/22-rdf-syntax-ns#’>

]>
<rdf:RDF xmlns:a=“&a;”

xmlns:rdf=“&rdf;”>

<a:IpSoftswitch rdf:about=“&a;bapna_00032”>

<a:iADList rdf:resource=“&a;bapna_00033”/>
<a:customerData rdf:resource=“&a;bapna_00034”/>
<a:QosList rdf:resource=“&a;bapna_00035”/>

</a:IPSoftswitch>
<a:iAD rdf:about=“&a;bapna_00033”>

<a:iADBandwidth>64kbps</a:iADBandwidth>
<a:model>uBR904</a:model>
<a:serial>12345</a:serial>
<a:vendor>cisco</a:vendor>

</a:iAD>
<a:CustomerData rdf:about=“&a;bapna_00034”>

<a:classOfService>1FRB</a:classOfService>
<a:customerBillingId>1010111</a:customerBillingId>
<a:customerName>Bapna</a:customerName>
<a:directoryNumber>(408)541 1422</a:directoryNumber>
<a:iADIpAddress>1.1.1.1</a:iADIpAddress>
<a:iADPort>0</a:iADPort>
<a:popID>Sunnyvale</a:popID>
<a:serviceArea>Sunnyvale</a:serviceArea>
<a:serviceID>VOIPSER1</a:serviceID>

</a:CustomerData>
<a:VoIPQos rdf:about=“&a;bapna_00035”>

<a:availability>99%</a:availability>
<a:capacity>64kbps</a:capacity>
<a:jitter>.01</a:jitter>
<a:latency>50ms</a:latency>

</a:VoIPQos>
</rdf:RDF>

What is claimed is:

1. A method for generating a fast busy signal in a data network comprising:
receiving a request to make a connection from a calling device to a called device at a predetermined level of quality of service (QOS);
retrieving resource information from a model to determine whether resources are available to make the connection at the predetermined level of QOS; and
providing a fast busy signal to the calling device if there are insufficient available resources to make the connection at the predetermined level of QOS.

2. The method of claim 1 wherein the connection is over the Internet.

3. The method of claim 1 wherein the connection is for a voice over data service.

4. The method of claim 3 wherein the voice over data service is selected from a group consisting of voice over IP, voice over xDSL, and voice over ATM.

5. The method of claim 1 wherein the fast busy signal is an audio tone.

6. The method of claim 1 wherein the fast busy signal is a data packet.

7. The method of claim 1 wherein the fast busy signal is a dialog box.

8. The method of claim 1 wherein the resources include available bandwidth.

9. The method of claim 1 wherein the model is in Resource Description Framework (RDF) format.

10. The method of claim 1 wherein the model contains information about a node.

11. The method of claim 1 wherein the model contains information about the calling device.

12. A data network comprising:
a softswitch;
a calling device and a called device;
a communications path between the calling and called devices; and
a resource information system (RIS) coupled to the softswitch, the RIS having access to a model containing information about resources on the data network, wherein the RIS is operable to inform the softswitch to initiate the sending of a fast busy signal to the calling device if there are insufficient resources to make a connection along the communications path at a predetermined level of quality of service (QOS).

13. The data network of claim 12 wherein the model is in Resource Description Framework (RDF) format.

14. The network of claim 12 wherein the calling device includes a computer.

15. The network of claim 12 wherein the calling device includes a traditional telephone.

16. The network of claim 12 wherein the communications path is part of the Internet.

17. The data network of claim 12 wherein the connection is for a voice over data service.

18. The network of claim 17 wherein the voice over data service includes voice over IP.

19. A method for generating a fast busy signal comprising:
providing a softswitch;
requesting the softswitch to make a connection between a first device and a second device at a predetermined level of quality of service (QOS);
querying a model to determine whether there are available resources to make the connection at the predetermined level of QOS; and
informing the switch to initiate the generation of a fast busy signal if the available resources are insufficient to make the connection at the predetermined level of QOS.

20. The method of claim 19 wherein the connection is for a multimedia service.

21. The method of claim 19 wherein the connection is for a voice over data service.

22. The method of claim 21 wherein the voice over data service includes voice over IP.

23. The method of claim 19 wherein the connection is over the Internet.

24. The method of claim 19 wherein the QOS includes bandwidth.
